(19) United States
(12) Patent Application Publication
(10) Pub. No.: US 2018/0087741 A1
(43) Pub. Date: Mar. 29, 2018

(54) MULTI-PURPOSE WATER RETURN APPARATUS

(71) Applicants: William James McFadyen, Flower Mound, TX (US); Reza Afshar, Newbury Park, CA (US); Rosolino Bommarito, Ontario (CA)

(72) Inventors: William James McFadyen, Flower Mound, TX (US); Reza Afshar, Newbury Park, CA (US); Rosolino Bommarito, Ontario (CA)

(21) Appl. No.: 15/280,948

(22) Filed: Sep. 29, 2016

(51) Int. Cl. F21V 3/02; E04H 4/12; E04H 4/14; F21V 31/00; F21V 3/04; F21V 17/12; F21V 19/00; F21V 17/16; G01D 11/26; G03B 21/14

(52) U.S. Cl. CPC F21V 3/02; E04H 4/12; E04H 4/148; F21V 31/005; F21V 3/0436; F21W 2131/401; F21V 19/006; F21V 17/164; G01D 11/26; G03B 21/145; F21V 17/12

(57) ABSTRACT

The water return apparatus of the present invention comprises a lens and a rear cover that couple together to create a sealed compartment into which electronic elements are encased. Furthermore, an adaptor couples the rear cover to a standard water return fitting of a water-bearing body, such as a swimming pool. Thus, the water return apparatus of the present invention replaces a traditional water return fitting in a swimming pool. In addition, the water return apparatus of the present invention allows for a first functional feature of facilitating the return of water to the water-bearing body and a second functional feature that is electronically driven, such as underwater lighting, underwater camera recording, underwater laser show, underwater projections, underwater sensing, and the like. Underwater sensing refers to the ability to incorporate various measuring sensors in the present inventions, such as sensors for water temperature, water clarity, movement, and the like.

### BACKGROUND OF THE INVENTION

### Field of the Invention

The present invention relates generally to the field of water return fittings for water-bearing bodies such as swimming pools, spas, tubs, fountains, and the like. More specifically, the present invention relates to a water return apparatus that allows for water to flow into said water-bearing body and allows for a second functional feature such as underwater lighting, underwater camera recording, underwater laser show, underwater projections, underwater sensing, and the like. Underwater sensing refers to the ability to incorporate various measuring sensors in the present inventions, such as sensors for water temperature, water clarity, movement, and the like.

### Description of the Prior Art

It is frequently desirable to illuminate water-bearing bodies such as swimming pools, spas, hot tubs, and fountains from below the water line. In these applications, lighting systems are often installed on and/or in the surfaces or walls of the water bearing body by coupling the lighting systems to a niche or other fitting. Such niches come in a plurality of sizes to accommodate lighting systems of various sizes. These lighting systems typically include a glass or plastic external lens, one or more lighting elements or light emitters, a circuit board, and one or more components for mounting the lighting system to the surface of the water-bearing body such that the external lens faces into the water-bearing body, and is exposed to the water contained therein. The external lens of such a lighting system typically defines at least a partially water-tight compartment within which the lighting elements are mounted to prevent water from breaching the cavity and causing a short circuit that could cause nearby bathers to be electrocuted.

Operation of such lighting systems causes the lighting elements to generate large amounts of heat. Build-up of heat within the lighting system (e.g., from the lighting element(s), microcontroller(s), and any other circuit elements) results in degradation in the performance and longevity of the lighting system. Where the lighting elements are light emitting diodes (“LEDs”), higher operating temperatures may result in the LED elements failing after a shorter operating lifespan. Thus, excess heat must be dissipated from the circuit board. The trend toward brighter lighting systems, using simultaneous combinations of active light elements, as well as the use of higher power light elements, exacerbates the heat problem. While water within the water-bearing body provides some cooling, it is insufficient to properly cool the lighting system because the water is typically still within the water-bearing body. Further, the temperature of the water is typically not sufficiently cold to cool an operating lighting system, especially in warmer climates. Therefore, in order to dissipate the heat generated by the lighting system, a conductive material is often needed. Previously, a heatsink was operatively coupled to the body of the lighting system to conduct the heat away from the circuit board and the lighting elements. However, such heatsinks increase the component and manufacturing cost of the lighting system. In addition, these heatsinks are often relatively large, because they are located within a fitting inside a cavity in the wall of a pool where air and/or water circulation is relatively low. The relatively low circulation of air and/or water in the wall cavity within which the heatsink is mounted require the relatively large heatsink to provide maximum material and surface area to dissipate the heat from the lighting elements.

However, most water-bearing bodies have at least one water inlet fitting connected to a water inlet pipe through which water is injected into the water-bearing body. Water flows through said water inlet pipe and fitting into the water-bearing body. Unlike a typical light niche in a water-bearing body into which a light is inserted, the water flow in a water inlet fitting is high. Thus, the heat related issues would be alleviated substantially if a lighting system were to be attached to a water inlet pipe and allow for both illumination of and flow of water into the water-bearing body.

Accordingly, it is desirable to provide a lighting system that can be attached to the of a water inlet pipe wherein water would flow around it so as to dissipate heat more efficiently than traditional lighting systems and eliminate the need for a heatsink. It is further desirable to provide a lighting system that is easy to install and replace in the water-bearing body by allowing it to be coupled to a standard pool fitting.

### BRIEF SUMMARY OF THE INVENTION

Accordingly, the present invention has been made in view of the above-mentioned disadvantages occurring in the prior art, and it is the object of the present invention to provide a water return apparatus installed within a water-bearing body and and having two functional features: (1) allowing water to flow into said water-bearing body; and (2) allowing electronic components enclosed therewithin to emit an underwater feature within said water-bearing body, such as underwater lighting, underwater camera recording, underwater laser show, underwater projections, underwater sensing, and the like. Underwater sensing refers to the ability to incorporate various measuring sensors in the present inventions, such as sensors for water temperature, water clarity, movement, and the like.

It is another object of the present invention to provide a water return apparatus with a sealed compartment that is watertight and spacious enough to enclose necessary electronic components to operate the second functional feature of the present invention.

It is yet another object of the present invention to provide a water return apparatus that can replace or be installed in the same location as a traditional water return fitting of a swimming pool or spa.

It is yet another object of the present invention to use an adaptor to direct the water returning to the water-bearing body and allow the remaining parts of the water return apparatus of the present invention to be locked into place.

It is yet another object of the present invention to provide a water return apparatus with sufficient holes through which water can effectively return to the water-bearing body.

It is yet another object of the present invention to provide a water return apparatus with a transparent lens that allows the second feature of the present invention to emit through into the water-bearing body.

To accomplish the above objects, the present invention is embodied in a water return apparatus comprising a rear cover that is attached to a lens forming a sealed compartment into which various electronic components that power the second functional feature is enclosed. The sealed compartment is watertight so as to protect the electronic components therewithin from water and moisture. The lens is transparent so as to allow the second functional feature to emit into the water within the water-bearing body. Such second functional feature can be underwater lighting, underwater camera recording, underwater laser show, underwater projections, underwater sensing and the like. Underwater sensing refers to the ability to incorporate various measuring sensors in the present inventions, such as sensors for water temperature, water clarity, movement, and the like. Then, an adaptor threads into a standard fitting so as replacing a traditional water return fitting. The adaptor has snap connector members that allow the lens and rear cover assembly to lock into position. Finally, the attachment of the adaptor to the lens and rear cover assembly creates a gap through which water returning to the water-bearing body passes and directs through various holes in the adaptor and in the lens. Thus, the water is allowed to flow into the water-bearing body, allowing the present invention to serve as a replacement for a traditional water return fitting. In addition to allowing water to flow into the water-bearing body, the present invention has the second functional feature that can be powered and controlled remotely.

The above and other features and advantages of the present invention, as well as the structure and operation of various embodiments of the present invention, are described in detail below with reference to the accompanying drawings.

### DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functional similar elements. A more complete appreciation of the invention and many of the attendant advantages thereof will be readily obtained as the same becomes better understood by reference to the following detailed description when considered in connection with the accompanying drawings, wherein:

FIGS. 1a and 1b show perspective views of a water return apparatus according to the present invention;

FIG. 2 shows an exploded view of a water return apparatus according to the present invention;

FIGS. 3a and 3b show perspective views of a lens as used in a water return apparatus according to the present invention;

FIGS. 4a and 4b show perspective views of a rear cover as used in a water return apparatus according to the present invention;

FIGS. 5a and 5b show perspective views of an adaptor as used in a water return apparatus according to the present invention; and

FIG. 6 shows a sectional view of a water return apparatus according to the present invention.

### DETAILED DESCRIPTION OF THE INVENTION

Certain terminology is used in the following description for convenience only and is not limiting. The words “right”, “left”, “lower”, and “upper” designate directions in the drawings to which reference is made. The words “inwardly” or “distally” and “outwardly” or “proximally” refer to directions toward and away from, respectively, the geometric center or orientation of the device and instruments and related parts thereof. The terminology includes the above-listed words, derivatives thereof, and words of similar import.

Although the present invention can be used in connection with any type of indoor or outdoor application, it is especially suited for underwater applications in connection with pools, spas, baths fountains, aquariums, and the like. Accordingly, the present invention will be described herein with reference to swimming pool applications, particularly for mounting the system to a standard one and one-half inch (1.5″) threaded pool fitting. However, the preferred system of the present application may also be adapted as a landscape system.

Reference will now be made to the drawings in which various elements of the present invention will be given numerical designations and in which the invention will be discussed so as to enable one skilled in the art to make and use the present invention.

The present invention comprises a water return apparatus 100 that attaches to standard fitting 210 located on the wall of a water-bearing body 200 and having a lens 10, a rear cover 20, and an adaptor 30. It is well known that water-bearing bodies 200 like swimming pools, recirculate the water therein. The water is sucked through a drain at the bottom and returned through a water return fitting along the side wall. The water return apparatus 100 of the present invention replaces a traditional water return fitting. The water return apparatus 100 of the present invention allows water to return into the water-bearing body 200 and allows for a second functional feature, such as underwater lighting, underwater camera recording, underwater laser show, underwater projections, underwater sensing and the like. Underwater sensing refers to the ability to incorporate various measuring sensors in the present inventions, such as sensors for water temperature, water clarity, movement, and the like.

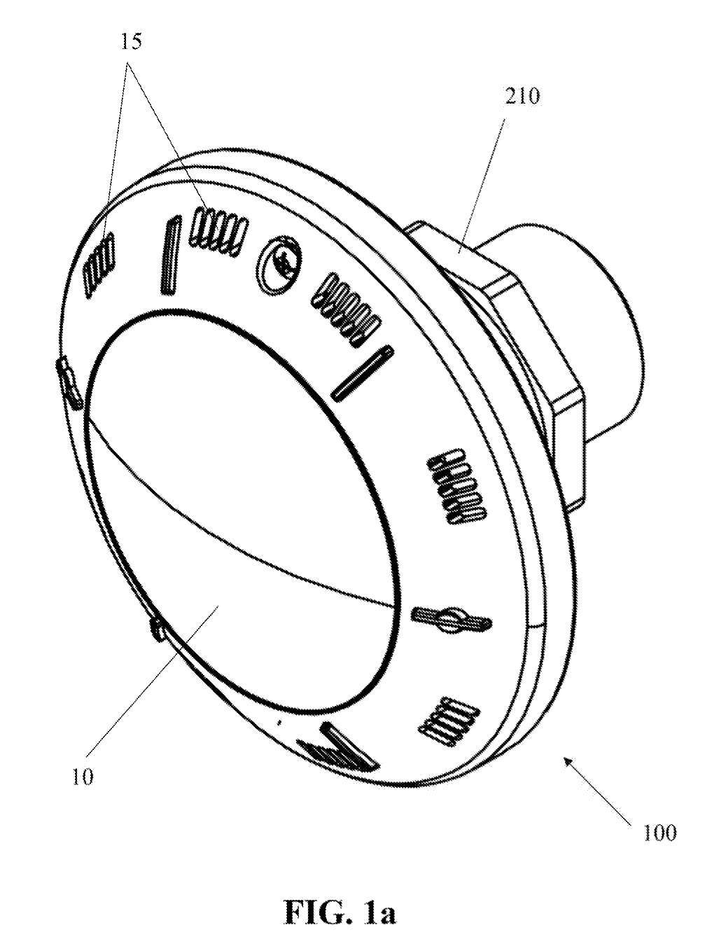

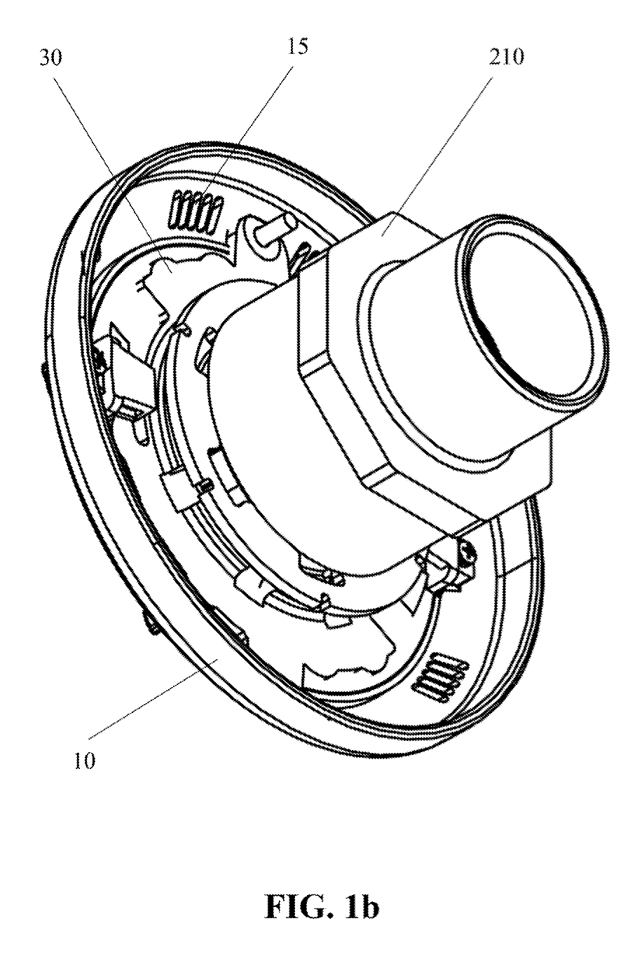

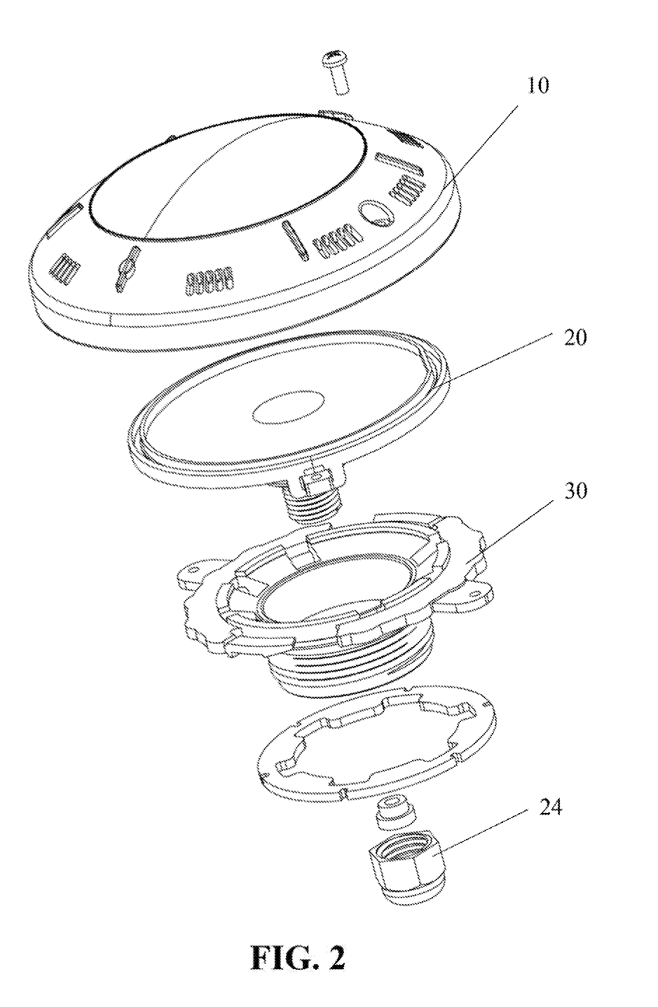

FIGS. 1a and 1b show perspective views of the water return apparatus 100 of the present invention in its assembled state as it would be installed within the water-bearing body 200. FIG. 2 shows an exploded view of the water return apparatus 100 of the present invention to depict in greater detail the various components that comprise the water return apparatus 100.

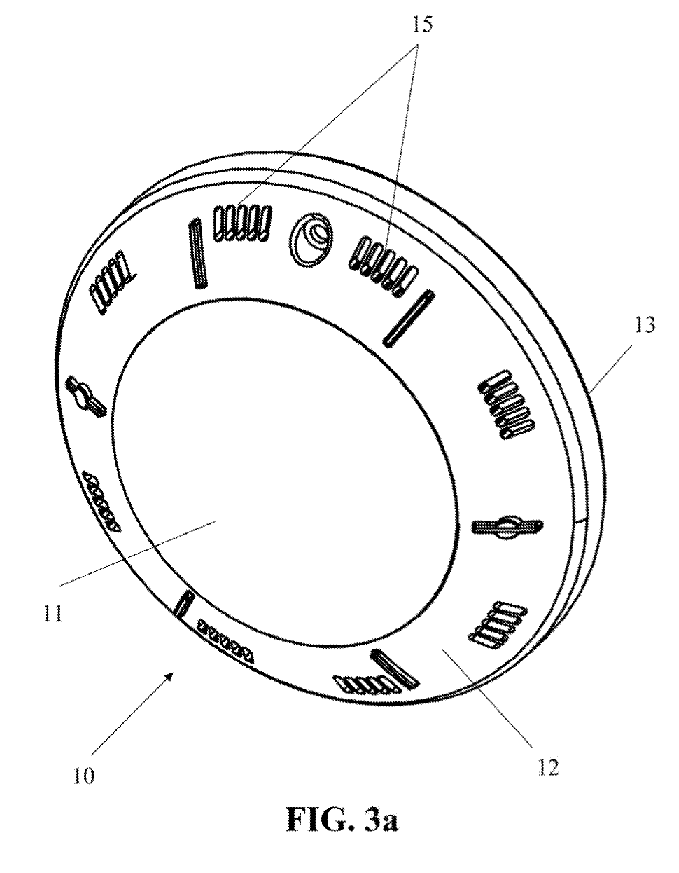

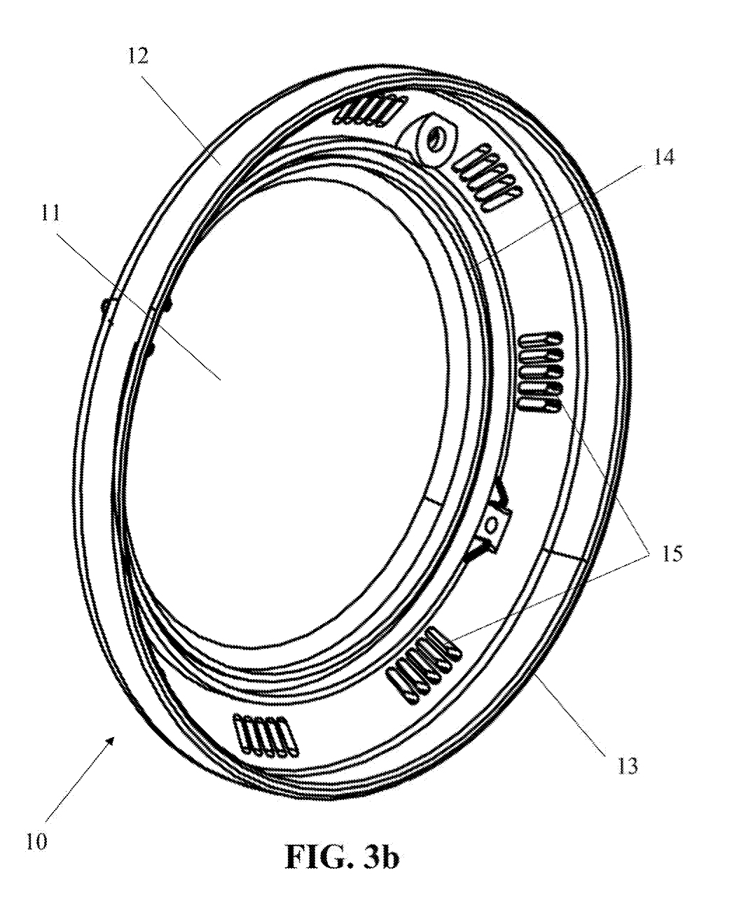

As shown in FIGS. 3a and 3b, the lens 10 is preferably curved to allow a circuit board, lighting elements, a camera, laser elements, projection elements, sensors, and the like, to be disposed in a sealed compartment 40 created between the lens 10 and the rear cover 20. In the preferred embodiment, the lens 10 is preferably dome-shaped. However, the lens 10 is not limited to dome-shapes and may be any other suitable shape, including, planar, oblong, rectangular, polygonal, cubed, or the like. The lens 10 may be constructed of different thicknesses. Preferably, the lens 10 has a transparent, semi-transparent, or translucent top portion 11 and sidewalls 12 that extend downward from the top portion 11, terminating at a first edge 13, which is generally circular in shape, but is not so limited and may take on nearly any shape, such as a star, oblong, oval, square, rectangular, or nearly any other shape that is desired by the user. The color, shape, and thickness of the top portion 11 and the sidewalls 12 of the lens 10 may be varied according to the desired application of the water return apparatus 100.

The lens 10 is preferably made of a transparent or semi-transparent plastic material, such as polycarbonate, polycarbonate alloy, optical glass, or the like. The material used for the lens 10 allows substantially all the light emitted from lighting elements to be emitted into the water in the water-bearing body 200 or onto landscaping when the present invention is adapted for landscape purposes. It is preferable that the selected material(s) for the lens 10 is scratch and dent resistant and that the material does not become cloudy in appearance after prolonged use. Therefore, combination materials (e.g., layers and/or coatings) may be applied to the lens 10 in order to, for example, provide the lens 10 with a scratch resistant coating or the like.

The lens 10 may be clear or alternatively, it may be any color that sufficiently transfers light into the water. In alternative embodiments, the lens 10 may be made of transparent or semi-transparent glass and glass-type materials. In some underwater applications, glass may be preferable over plastic materials due to its higher thermal conductivity. Therefore, glass may provide additional cooling through the external interface between the lens 10 and the water in the water-bearing body 200.

The lens 10 has a second edge 14 extending on a plane that is generally parallel to the first edge 13. However, in the preferred embodiment of the present invention, the second edge 14 is generally perpendicular to the wall of the water-bearing body 200. The second edge 14 is shaped to maintain the rear cover 20 in a fixed position within the lens 10 and is preferably utilized as a sealing location for insertion of a gasket or like material to provide the sealed compartment 40. Additionally, the lens 10 has a plurality of holes 15 throughout the sidewalls 12 and the first edge 13. In the preferred embodiment, the holes 15 must be on the lens 10 in between the first edge 13 and the second edge 14. The holes 15 cannot be within the sealed compartment 40.

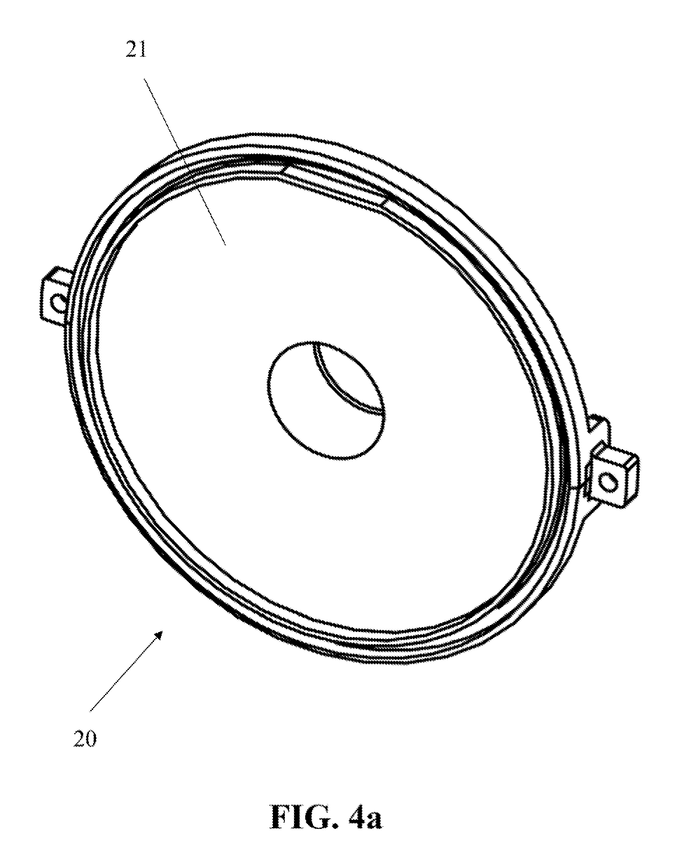

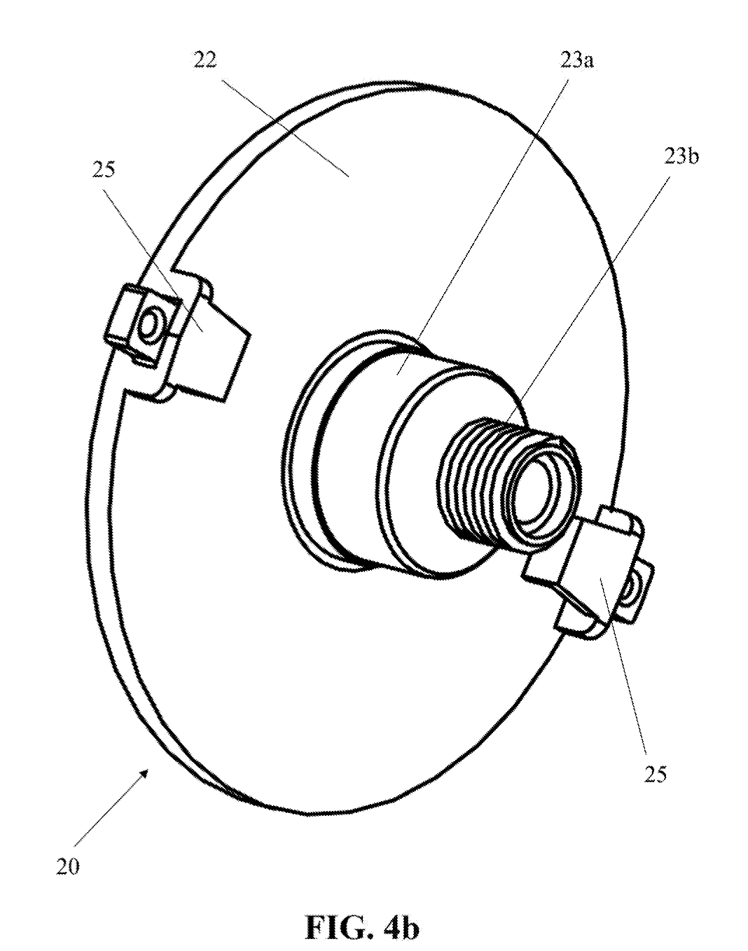

As shown in FIGS. 4a and 4b, the rear cover 20 has a first side 21 and a second side 22 and is preferably circular or rounded in shape. The first side 21 preferably holds any element that is inserted into the sealed compartment 40, such as a circuit board, lighting elements, laser elements, projection elements, sensors, and the like. In the preferred embodiment, the rear cover 20 has an overall diameter of approximately three inches (3′). However, where additional elements are desired inside the sealed compartment 40 or where a larger or smaller design of the water return apparatus 100 is preferable, the rear cover 20 and the lens 10 may be as big as twelve inches (12″) or larger and may be smaller, depending upon user preference. Regardless, the selected diameter of the rear cover 20, it is preferable that the diameter of the rear cover 20 is smaller than the diameter of the lens 10. In the preferred embodiment of the present invention, the diameter of the rear cover 20 is substantially similar to the diameter of the second edge 14 of the lens 10. Such similarity in diameter allows the rear cover 20 to be maintained by the second edge 14 in a fixed position within the lens 10.

The second side 22 of the rear cover 20 has a plurality of snap connector members 25 arranged thereon, specifically two (2) snap connector members 25 in the preferred embodiment. Each of the snap connector members 25 preferably has a channel for accepting a hook member 35 of the adaptor 30 when the adaptor 30 is in the locked position. While FIG. 4b depicts two (2) snap connector members 25 arranged at opposite ends of the rear cover 20, less or more snap connector members 25 may be arranged. While the snap connector members 25 are preferably at opposite ends of the rear cover 20, they may also be positioned at different points on the rear cover 20 without departing from the scope of the present invention. Furthermore, while snap connector members 25 are preferred, other types of connectors and fasteners may be used to removably couple the adaptor 30 to the rear cover 20. Such connectors and fasteners may include hook and loop materials, clamps, adhesives, spikes, screws or other related connectors and fasteners to releasably secure the rear cover 20 to the adaptor 30 and are within the scope of the present invention. In other embodiments, the adaptor 30 may be coupled directly to the lens 10 instead of or in addition to the rear cover 20. For example, a plurality of bolts or other fasteners may be used to couple the lens 10 to the adaptor 30 at a plurality of through holes. Similarly, the snap connector members 25 may be arranged on the inside of the lens 10 instead or in addition to the rear cover 20.

Additionally, the second side 22 of the rear cover 20 includes a threaded coupling 23 for engaging a cable nut 24. The threaded coupling 23 accepts a cable 60 and the cable nut 24 releasably fixes the cable 60 while creating a generally watertight pressure fit.

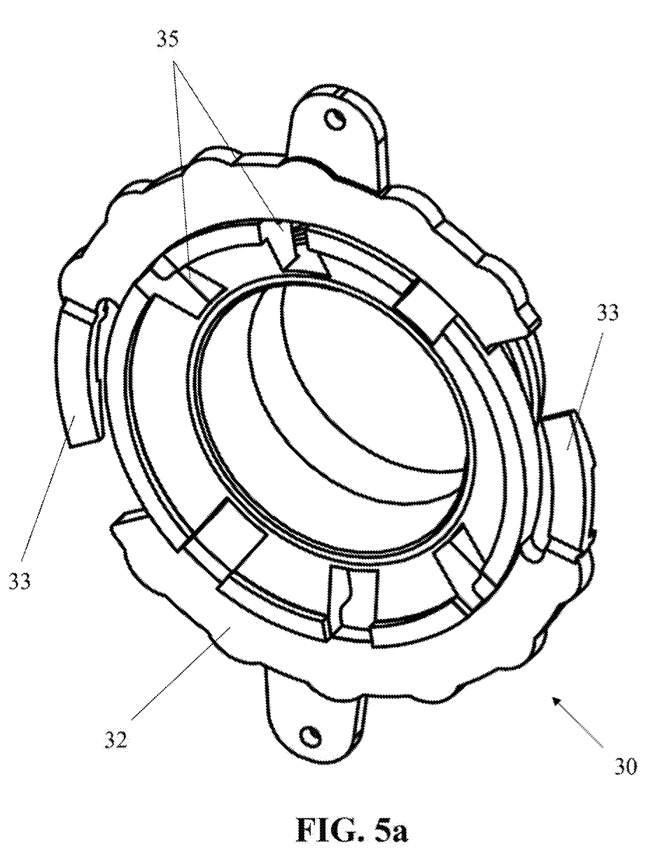

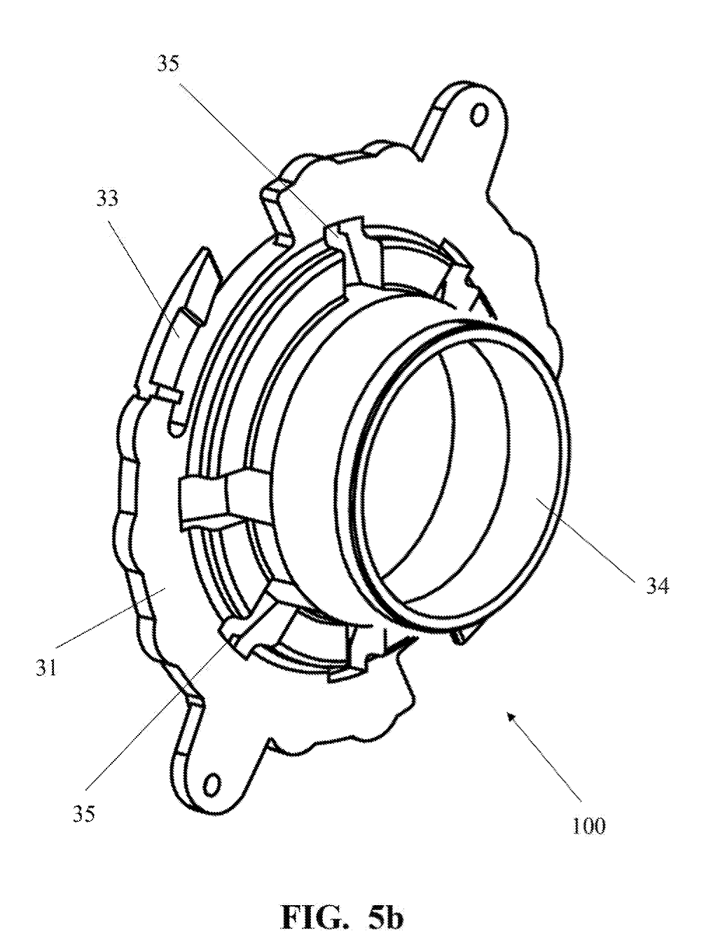

As shown in FIGS. 5a and 5b, the adaptor 30 has a front side 32 that interfaces with the second side 22 of the rear cover 20. A plurality of elongated hook members 33 are arranged at the periphery of the adaptor 30. Preferably, the hook members 33 are disposed at opposite ends of the adaptor 30 such that they may simultaneously engage with the snap connector members 25 of the rear cover 20. Engagement of the hook members 33 with the snap connector members 25 results in a locked position of the water return apparatus 100 of the present invention. Such locked position occurs by twisting the adaptor 30 against the rear cover 20 until the hook members 33 fully engage and snap into the snap connector members 25. Preferably, the snap connector members 25 are slightly undersized relative to the hook members 33 to create a pressure fit between these elements in the locked position.

The adaptor 30 also has a rear side 31 from which a threaded coupling 34 protrudes. Thus, the water return apparatus 100 of the present invention is preferably mounted to the standard fitting 210 by threading the threaded coupling 34 of the adaptor 30 thereto.

Preferably, the standard fitting 210 is a standard one and one-half inch (1.5″) fitting having a plurality of threads. The standard fitting 210 is mounted in the wall or other surface of the water-bearing body, such as a pool, spa, or hot tub. The threaded coupling 34 of the adaptor 30 is twisted along the threads into the standard fitting 210 until the adaptor 30 and the fitting 210 are tightly coupled with one another. One end of the cable 60 is guided through the adaptor 30 and the fitting 210 to the remote power supply. Once the adaptor 30 is threadably coupled to the fitting 210, the remaining portion of the water return apparatus 100 of the present invention is coupled to the adaptor 30 by engaging the hook members 33 with the snap connector members 25 to place the water return apparatus 100 in the locked position. When the water return apparatus 100 is mounted to the fitting 210, the cable 60 passes through the fitting 210 and into the wall of the water-bearing body 200.

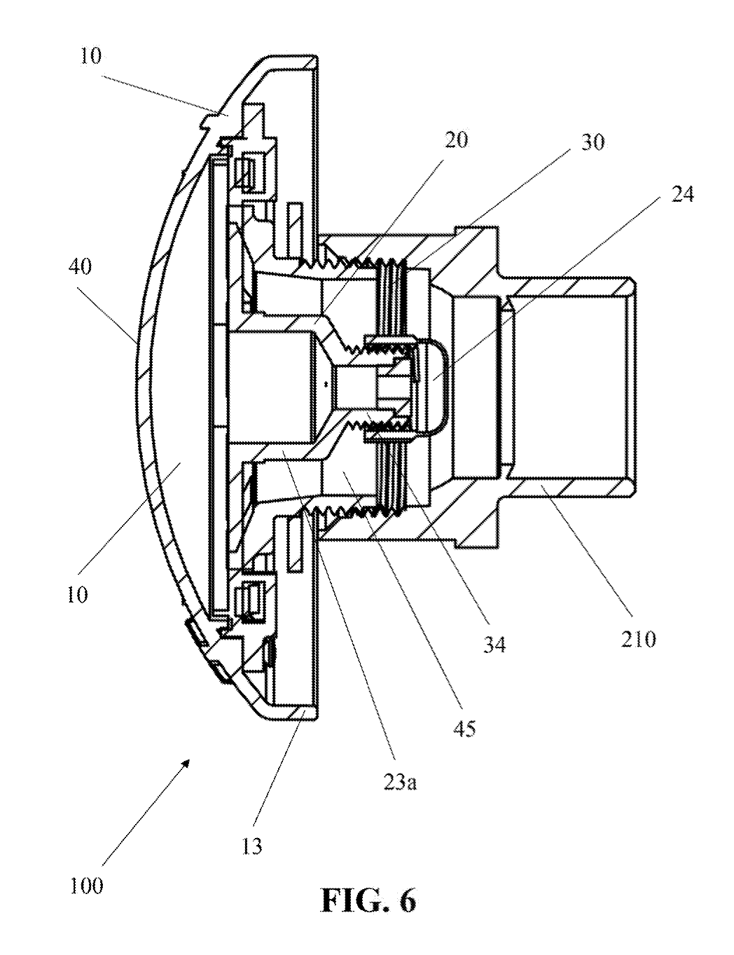

Furthermore, the adaptor 30 has a plurality of holes 35 that, when engaged in the locked position with the rear cover 20, reside within the lens 10 and above the first edge 13 as shown in FIG. 6. Even more, the inside diameter of the threaded coupling 34 of the adaptor 30 is greater than the outside diameter of the threaded coupling 23 of the rear cover 20. Thus, when the hook members 33 are engaged with the snap connector members 25, a gap 45 between the threaded coupling 34 of the adaptor 30 and the threaded coupling 23 of the rear cover 20 is substantial.

Hereinafter, an explanation of the methods of assembling the water return apparatus 100 of the present invention, the operating states thereof, and the usage thereof will be given.

As shown in FIG. 6, the main components of the water return apparatus 100 of the present invention include a lens 10, a rear cover 20, and an adaptor 30. The lens 10 and the rear cover 20 are attached together so as to create a sealed compartment 40. The attachment of the lens 10 to the rear cover 20 is sealed watertight. Such watertight seal can be attained by the use of a gasket, o-ring, or like material. In addition, the size of the threaded coupling 23 of the rear cover 20 can vary so as to increase or decrease the size of the sealed compartment 40. In the preferred embodiment, the threaded coupling 23 is designed in two tiers: a wider top tier 23a and a narrower bottom tier 23b. Such tow-tier configuration allows the sealed compartment 40 to enclose more components as needed for the second functional feature of the water return apparatus 100 of the present invention, such as, underwater lighting, underwater camera recording, underwater laser show, underwater projections, underwater sensing, and the like. Underwater sensing refers to the ability to incorporate various measuring sensors in the present inventions, such as sensors for water temperature, water clarity, movement, and the like.

Therefore, various necessary components for said second functional feature are packed and enclosed within the sealed compartment 40. Such components typically comprise a circuit board, lighting elements, laser elements, image projecting elements, and the like. Ultimately, said components are electrically connected together with a cable 60 extending therefrom. Said cable 60 is a bundle of a plurality of wires electrically connected to the various components. When said components are enclosed within the sealed compartment 40 and the rear cover 20 is attached to the lens 10, the cable 60 extends out of the sealed compartment 40 through the threaded coupling 23 of the rear cover 20 and through the cable nut 24 that is attached to the threaded coupling 23. The attachment of the cable nut 24 and the threaded coupling 23 is watertight as is the interface between the cable nut 24 and the cable 60. As such, the sealed compartment 40 is sealed watertight the various electronic components enclosed therewithin.

Once the sealed compartment 40 with all of the required electronic components enclosed therewithin is completed, the water return apparatus 100 of the present invention is ready for installation. First, the threaded coupling 34 of the adaptor 30 is twisted along the threads into the standard fitting 210 until the adaptor 30 and the standard fitting 210 are tightly coupled with one another. Second, the cable 60 extending out of the sealed compartment 40 through the cable nut 24 is fed through the adaptor 30 and standard fitting 210 and in through the wall or a pipe within the wall of the water-bearing body 200 until it is ultimately connected to a remote power source or a controller that powers and controls the electronic components within the sealed compartment 40. Finally, the remaining portion of the present invention, which comprises of the lens 10, the rear cover 20, and the cable nut 24, is coupled to the adaptor 30 by engaging the hook members 33 with the snap connector members 25 to place the water return apparatus 100 in the locked position.

Once the water return apparatus 100 of the present invention is in the locked position and attached to the standard fitting 210 of a water-bearing body, the water returned to the water-bearing body 200 through said standard fitting 210 is directed into the gap 45 between the threaded coupling 34 of the adaptor 30 and the threaded coupling 23 of the rear cover 20. Thereafter, the water is directed out of the gap 45 through the holes 35 in the adaptor 30 and into the lens 10. Finally, the water is directed out of the lens 10 through the holes 15 in the lens 10 and into the water-bearing body 200. As the water passes through the water return apparatus 100 of the present invention, it is kept out of the electronic components within the sealed compartment 40 by the watertight attachments that form said sealed compartment 40.

In addition, after the water return apparatus 100 of the present invention is attached to the standard fitting 210 of a water-bearing body 200, the electronic components within the sealed compartment 40 can be powered to activate the second functional feature of the present invention, such as underwater lighting, underwater camera recording, underwater laser show, underwater projections, underwater sensing, and the like. Underwater sensing refers to the ability to incorporate various measuring sensors in the present inventions, such as sensors for water temperature, water clarity, movement, and the like. Thus, the present invention replaces a traditional water return fitting without inhibiting the water flow returning to the water-bearing body 200 but also adding a second functional feature that lacks from a traditional water return fitting.

It is understood that the described embodiments of the present invention are illustrative only, and that modifications thereof may occur to those skilled in the art. Accordingly, this invention is not to be regarded as limited to the embodiments disclosed, but to be limited only as defined by the appended claims herein.

1: A water return apparatus comprising:
a lens that is sealingly coupled to a rear cover to create a sealed compartment therebetween;
a first coupling that extends from said rear cover;
an adaptor having a front side that is coupled to said rear cover and a rear side that has a second coupling extending therefrom;
a first plurality of holes in said adapter and a second plurality of holes in said lens;
a gap that is created between said first coupling and said second coupling when said adaptor is coupled to said rear cover;
wherein said second coupling of said adaptor is coupled to a fitting of a water-bearing body through which water flows;
whereby said water is directed into said gap then out said first plurality of holes then out said second plurality of holes into said water-bearing body; and
an electronic element encased within said sealed component.

2: The water return apparatus of claim 1, wherein said electronic element comprises a lighting element.

3: The water return apparatus of claim 1, wherein said electronic element comprises a projection element.

4: The water return apparatus of claim 1, wherein said electronic element comprises a camera.

5: The water return apparatus of claim 1, wherein said electronic element comprises a sensor.

6: The water return apparatus of claim 1, wherein said fitting is a standard one and one-half inch (1.5″) water return fitting of a swimming pool

7: The water return apparatus of claim 1, wherein said lens is dome-shaped.

8: The water return apparatus of claim 1, wherein said lens is made of a transparent plastic material.

9: The water return apparatus of claim 1, wherein said rear cover further comprises a first side to which said electronic element is attached and a second side that is coupled with said adaptor.

10: The water return apparatus of claim 1, wherein said rear cover further comprises a plurality of snap connector members and said adaptor further comprises a plurality of hook members such that engagement of said hook members with said snap connector members locks said water return apparatus in a fixed position.

11: A water return apparatus comprising:
a lens that is sealingly coupled to a rear cover to create a sealed compartment therebetween;
an adaptor having a front side that is coupled to said rear cover and a rear side that is coupled to a fitting of a water-bearing body through which water flows;
whereby said water is directed through a plurality of holes into said water-bearing body; and
an electronic element encased within said sealed compartment.

12: The water return apparatus of claim 11, wherein said electronic element comprises a lighting element.

13: The water return apparatus of claim 11, wherein said electronic element comprises a projection element.

14: The water return apparatus of claim 11, wherein said electronic element comprises a camera.

15: The water return apparatus of claim 11, wherein said electronic element comprises a sensor.

16: The water return apparatus of claim 11, wherein said fitting is a standard one and one-half inch (1.5″) water return fitting of a swimming pool.

17: The water return apparatus of claim 11, wherein said lens is dome-shaped.

18: The water return apparatus of claim 11, wherein said lens is made of a transparent plastic material.

19: The water return apparatus of claim 11, wherein said rear cover further comprises a first side to which said electronic element is attached and a second side that is coupled with said adaptor.

20: The water return apparatus of claim 11, wherein said rear cover further comprises a plurality of snap connector members and said adaptor further comprises a plurality of hook members such that engagement of said hook members with said snap connector members locks said water return apparatus in a fixed position.

21: A water return apparatus comprising:
a sealed compartment created by a rear cover;
an adaptor having a front side that is coupled to said rear cover and a rear side that is coupled to a fitting of a water-bearing body through which water flows;
whereby said water is directed through a plurality of holes into said water-bearing body; and
an electronic element encased within said sealed compartment.

22: The water return apparatus of claim 21, wherein said electronic element comprises a lighting element.

23: The water return apparatus of claim 21, wherein said electronic element comprises a projection element.

24: The water return apparatus of claim 21, wherein said electronic element comprises a camera.

25: The water return apparatus of claim 21, wherein said electronic element comprises a sensor.

26: The water return apparatus of claim 21, wherein said fitting is a standard one and one-half inch (1.5″) water return fitting of a swimming pool.

27: The water return apparatus of claim 21, wherein said rear cover further comprises a first side to which said electronic element is attached and a second side that is coupled with said adaptor.

28: The water return apparatus of claim 21, wherein said rear cover further comprises a plurality of snap connector members and said adaptor further comprises a plurality of hook members such that engagement of said hook members with said snap connector members locks said water return apparatus in a fixed position.
